(19) United States
(12) Patent Application Publication
(10) Pub. No.: US 2019/0075285 A1
(43) Pub. Date: Mar. 7, 2019

(54) DEVICE AND METHOD TO RECONSTRUCT IN 3D THE SURFACE OF A COMPLETE LOOP AROUND A SUBJECT

(71) Applicant: Jean-Philippe THIRION, Valbonne (FR)

(72) Inventor: Jean-Philippe THIRION, Valbonne (FR)

(73) Assignee: QuantifiCare, Valbonne (FR)

(21) Appl. No.: 16/039,360

(22) Filed: Jul. 19, 2018

(30) Foreign Application Priority Data
Sep. 6, 2017 (FR) FR1770938

(51) Int. Cl. H04N 13/282; H04N 13/221; H04N 13/218; H04N 13/296

(52) U.S. Cl. CPC H04N 13/282; H04N 13/296; H04N 13/218; H04N 13/221

(57) ABSTRACT

The device and method are intended for reconstructing in 3-Dimensions a complete 360° loop of a subject (30).

The device and method is comprising using a passive stereovision 3D camera (10) and either a turn table (20) or alternatively a rotating frame (21) carrying the 3D camera in order to acquire a set of stereo pairs covering a complete 360° loop around the subject (30) and enabling reconstructing (60) the 3D surfaces and associated texture images associated to said stereo pairs and to stitch (80) these 3D surfaces into a comprehensive 3D surface with associated texture image in order to represent over 360° the imaged subject (30).

The invention is particularly intended for the 3D reconstruction of 360° loops of the body of people for measurement and surgical simulation in aesthetics.

### BACKGROUND INFORMATION

The present invention relates to a device and a method to reconstruct in three dimensions (3D) a complete 360° loop around an object or a body.

Numerous applications are existing making use of a 3D representation of an object under multiple orientations. It can be for example viewing objects remotely for telemarketing. Hence several systems making use of a turn table and based upon the acquisition of photographic pictures or movies have been proposed, such as by Beniyama et al. in U.S. Pat. No. 7,440,691, by Park et al. in U.S. Pat. No. 7,394,977 or more recently by McGuire et al. in U.S. Pat. No. 8,462,206.

In all of these cases, a large number of images acquired according to different viewpoints are taken by using either a conventional camera or video camera of a subject placed on a turn table. These systems are characterized according to the number of degrees of freedom of the turn table and/or the possibilities to orient or move the camera. They are also characterized by the user interface and the way pictures or movies are played back during the visualization stage.

In these mentioned patents, there is no intention to reconstruct the surface of an object in 3D, but to collect a set of views which can enable a user to visualize a posteriori an object according to a vast set of directions in space, and provides the user with the illusion that it is moving the 3D object in space, including the possibility to play the record of a full turn of the object.

Relative to 3D surface reconstruction techniques, the majority of stereovision techniques are using a fixed position 3D camera and a fixed position object. 3D stereovision techniques can be broadly subdivided into two groups:
Active stereovision techniques, making use on one side of a video camera and on the other side a structured light projector. The light pattern is projected onto the subject and then the pattern is imaged with the video camera and a shape is reconstructed in 3D from the interpretation of the shape of the projected pattern and continuity hypotheses about the reconstructed surface as registered by the video camera. The structured light most frequently used are either a laser beam scanner or an infrared light.
Passive stereovision techniques, making use of a single photographic camera body and equipped with a dual optics enabling simultaneous acquisition of two views of the same subject acquired with two different viewing angles, which is providing a stereographic pair of images called “stereo-pair”. Specific algorithms are then used to reconstruct in 3D a surface of the object along with an associated high-resolution texture image. Such 3D reconstruction algorithms, called stereophotogrammetry, are matching the pixels in the two images of a stereo-pair and, by knowing the different relative positions and orientations of the two sub-optics of the double optics, enable 3D surface reconstruction via triangulation. In such case, it is needed to perfectly know in advance the geometric characteristics of both sub-optics of the double-optics. U.S. Pat. No. 9,621,875 presents an example of such passive stereovision camera and associated surface reconstruction methods.

Other techniques, distinct from above-mentioned passive stereovision techniques and based on optical flow also exist in order to reconstruct an object in 3D from a single video sequence obtained with a conventional video camera and complete rotation of an object on a turn table. One such example is presented by A. W Fitzgibbon et al. in “Automatic 3D Model Construction for Turn-Table Sequences”, SMILE'98, Proceedings of the European Workshop on 3D Structure from Multiple Images of Large-Scale Environments, Pages 155-170, Jun. 6-7, 1998.

One interesting advantage of this last technique is not only to get a 3D reconstruction of the surface of the subject, but also an associated complete 360° video loop of that subject—and evidently by using a conventional video camera and not a specific 3D optics.

Finally, other techniques have been developed to reconstruct a 360° complete loop of the 3D surface of an object or a body, making use of an active stereovision system and a turn table. Indeed one advantage of active stereovision is to enable progressive 3D reconstruction via a continuous scan of the surface. A cloud of 3D points, representative of the surface is constituted and permanently enriched each time a new scan of the surface is performed. It is therefore quite natural to associate a continuous scanning system with a continuous rotation device to rotate the camera around the subject, or conversely and equivalently, to continuously rotate the subject in front of a fixed active stereovision camera.

A first example is described by K. Park in the U.S. Pat. No. 7,020,325 in the case of the 3D reconstruction of a tooth. This system is using a laser beam scanner and a video camera that is recording an image sequence of the light pattern projected onto the object and placed on a turn table in order to reconstruct its 3D surface. Such ideas of combining active stereovision and a turn table are developed further by Weber et al. in the U.S. Pat. No. 8,982,201, enabling applications to complete dentition.

More recently, and in the case of a body, the Styku Company, Los Angeles, Calif., US has developed a “Bodyscanner” making use of a turn table and a fixed position active stereovision camera. The active stereovision system used is the “Kinect V2”, which is a video camera making use of infrared-based projector and captor to evaluate a depth map and hence reconstruct 360° tours of objects or people. This type of methods is in the continuation of methods proposed by Wang et al. in “Accurate Full Body Scanning from a Single Fixed 3D Camera”, 2012 Second International Conference on 3D Imaging, Modeling, Processing, Visualization & Transmission, October 13-15, Zurich, Switzerland, which are making use of active vision systems such as the Kynect and infrared sensors. Conversely, the Company Shape Labs Inc., San Francisco, Calif., is proposing via its “Shapescale” product to make an active stereovision camera of a Kynect type to rotate around a subject. In all these examples, the rotation of the camera around the subject is continuous.

However, whether in Fitzgibbon, Park or Weber, or in the case of Styku's “bodyscanner”, the use of a video camera to collect images is reducing the resolution of the acquired images. Indeed, due to the important, but limited bandwidth of a video camera, the image resolution is forced to be reduced when compared with the resolution of a high resolution digital camera. This latter device is generally exhibiting a number of pixels which is an order of magnitude higher that of a video camera, as well as a generally with very superior image quality. Furthermore, projecting light pattern can reduce the quality of the acquired image texture.

To overcome this issue of having reduced resolution images with active stereovision due to video camera and if one is associating an additional, more classical photographic camera system to complement the 3D model with higher resolution texture, then the difficulty to overcome is the matching of the additional high-resolution image with the geometry of the surface, because the image texture, then acquired independently from the video images used to reconstruct the shape, may be shifted relative to the 3D surface.

Hence 3D reconstruction methods making use of a video camera and/or projected light patterns for 3D reconstruction are limited relative to the quality and accuracy of the texture image associated with reconstructed 3D surface.

On the contrary to active stereovision systems, passive stereovision techniques have been developed to reconstruct in 3D the surfaces of objects from stereo pairs of images acquired with very high resolution from camera equipped with double-optics enabling the reconstruction in three-dimensions of the surface of an object, with associated high-resolution texture image. Such texture image benefits from the high quality advantaged of available camera bodies. Furthermore, as the high resolution images of the image pair are themselves used to perform 3D reconstruction, the matching of the image texture and the 3D model is ensured to be optimal.

To overcome the fact that, in a single picture taking, a passive stereovision system is enabling acquiring only a part of the surface of the object, due to “hidden parts” invisible from a single point of view, additional surface stitching techniques have been developed over the recent years in order to reconstruct comprehensive 3D surface from several stereo pairs of the target subject acquired according to different viewpoints.

The invention being disclosed aim at adapting a passive stereovision camera system and 3D surface stitching methods and using a turn table in order to reconstruct in 3D a complete 360° loop of an object or a body with associated very high resolution image texture.

### BRIEF SUMMARY OF THE INVENTION

The invention is disclosing a device and a method to reconstruct in 3D the surface of a complete 360° loop of an object or a body comprising on one side at least one passive stereovision 3D camera including a double-optics and on the other side a turn table or equivalently a turning frame rotating at least one passive stereovision 3D camera around the subject, and then stitching the 3D surfaces corresponding to the views according to several orientations in a single comprehensive 3D representation of the surface of the object or of the body.

Such high quality 3D reconstruction cannot be obtained with the acquisitions obtained with conventional multiple views. Indeed, even if a 3D reconstruction can be attempted from two views performed according to different orientations and the same camera which have been displaced, or with two distinct synchronized cameras, the calibration, that is, the knowledge of the intrinsic relative position of such two cameras or such two successive positions of the same camera, is much less accurate than when a stereo pair is acquired with a single camera body comprising a compact double-optics block.

Indeed, in the case of a double-optics block, the accuracy of the relative the sub-optics positions can reach down to one micron. On the contrary, it is very difficult with two separate camera bodies or a single camera body moving in space to know these relative positions down to one millimeter. One could think about adding metrology apparatus to accurately measure the position of the different camera bodies, but such metrology apparatus are very costly and may be quite difficult to operate.

As an example, the pieces maintaining together two distinct camera bodies are subjective to variations due to temperature changes, or gravity changes in case of orientation change, that are decreasing the accuracy of the estimation of the relative position and orientation of the two camera bodies.

One advantage of a device according to the present invention is therefore to enable combining the extreme accuracy of 3D surface reconstruction with the extreme details of the associated image texture of a passive stereovision camera system with double-optics and the possibility to acquire a complete 360° loop of the subject thanks to a turn-table and a 3D surface stitching algorithm. Relative to accuracy, the result is superior to the accuracy obtained using simple 1-view cameras or with an active stereovision video camera.

One would understand that in the present invention, it is equivalent to use a turn table to rotate the subject in front of at least one passive stereovision 3D camera, or to rotate at least one passive stereovision 3D camera around the subject by using a rotating frame. Same equivalence applies to the method according to the invention.

### BRIEF DESCRIPTION OF THE SEVERAL VIEWS OF THE DRAWING

FIG. 1 is presenting a possible implementation of the device, using a turn table.

FIG. 2 is presenting a possible implementation of the device, using a rotating frame carrying a 3D stereophotogrammetry camera.

FIG. 3 is presenting the steps of the method making use of a turn table.

FIG. 4 is presenting the steps of the method making use of a rotating frame carrying a 3D stereophotogrammetry camera.

### DETAILED DESCRIPTION OF THE INVENTION

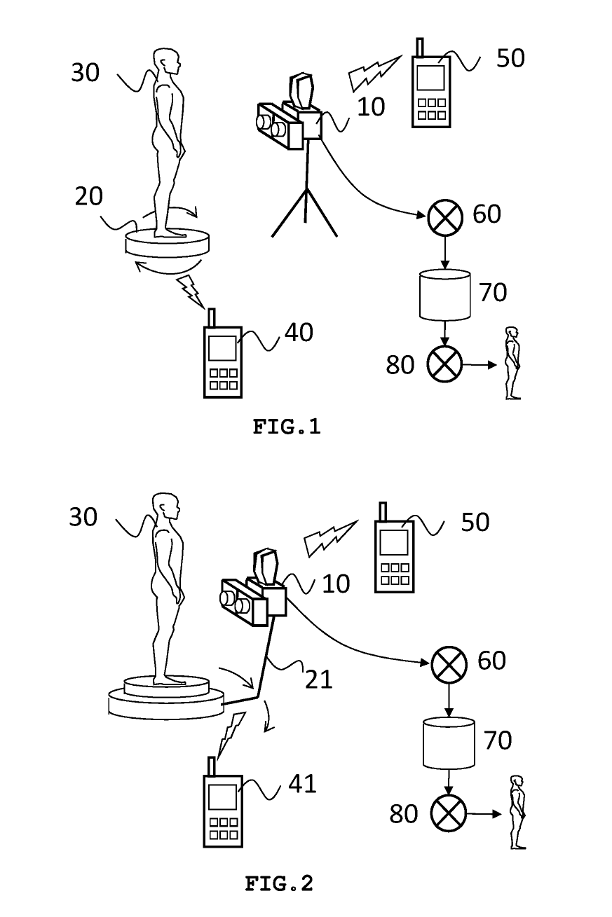

By reference to these drawing, a possible implementation of a device according to the invention is presented in FIG. 1, including:

a passive stereovision 3D camera (10),

a turn table (20),

an object or a body (30) placed on the turn table (20), so that the object or body (30) is within the field of view of the 3D camera (10),

a control mean controlling the rotation (40) of the rotating table (20),

a control mean enabling triggering (50) the 3D camera (10),

computation means for the reconstruction in 3D of a surface and associated texture image (60) from a stereo pair acquired with the 3D camera (10),

a storage mean (70) to store the 3D surfaces and associated texture images corresponding to the different viewing angles of the object or body (30),

computation means for the stitching in a single 3D surface and associated texture (80) of a full 360° loop around the imaged object or body (30) stored in the storage mean (70).

The stereovision 3D camera (10) can include a double-optics producing stereo pairs of images. The double-optics is to be understood in its broadest meaning, including the possibility to comprise a splitter composed of reflecting mirrors placed in front of a single lens system or in front of two separate lens systems, or be composed of two independent lens systems without the need of a splitter with mirrors, or made by two distinct and rigidly linked camera bodies with separate optics or any other type of stereovision 3D camera enabling producing stereo pairs of images. The 3D camera (10) can also include a single photosensitive surface acquiring a stereo pair of images or two distinct photosensitive surfaces, each acquiring one image of the stereo pair.

360° loop stitching (80) is composed of the sub-steps of matching the 3D surface elements between themselves, for example by using an Iterative Closest Point algorithm (ICP) which alternatively finds corresponding points between two overlapping surfaces and minimizes the distance between matched points using least square minimization. 360° loop stitching can also encompass a step of minimizing the matching errors between the different 3D surfaces, taking into account that the set of 3D surfaces is constituting a loop, and hence increasing the accuracy of the stitched 3D surface via such minimization, by adjusting the different surfaces positions in an attempt to evenly spread residual errors.

The control mean (40) enabling the activation of the rotation of the turn table (20) can be linked to it via a cable or any other electronic communication mean such as electromagnetic transmission, infra-red, Bluetooth, WIFI, radio or any other electromagnetic wave or signal. It can also be a system integrated to the turn table and synchronized to a clock in order to achieve pre-defined rotation positions of the turn table over time.

The control mean (50) enabling the triggering of picture taking with the 3D camera (10) can be a remote control cable linked to the 3D camera body (10) or any other type of electromagnetic remote triggering like transmission of an infra-red, Bluetooth, WIFI, radio or any other electromagnetic wave or signal. It can also be a synchronization of the triggering via a clock in order to trigger picture taking at regular time points, possibly synchronized with the rotating system. Such clock can be integrated to the 3D camera (10) itself.

The storage mean (70) to store 3D surfaces and associated texture images can be integrated with the computation mean (80) used to stitch the 3D surfaces and associated texture images corresponding to the different views of the complete 360° loop of the subject in a comprehensive representation of a 3D surface and associated texture image of the object or body (30). The advantage of such an integration is that the stitching operation can start while the complete turn is not yet finished, reducing overall process duration.

In the same way, the computation means (60) enabling reconstructing a 3D surface and associated texture image from a stereo pair can be integrated to the computation means (80) used for stitching in order to factorize the necessary computation means.

It can be useful to combine the control mean (40) for the rotation of the turn table (20) and the remote triggering mean (50) of the 3D camera (10) into a single control mean (40-50) in order to perfectly synchronize the angles set for the turn table (20) and the picture taking using the 3D camera (10).

There is an advantage also that the control mean (40) for the turn table rotation (20) is such that it suspends rotation of the turn table (20) during picture taking, so that it is reducing the motion blur which would arise from the speed of rotation of the turn table (20) during picture taking

It is an advantage to combine the control means (40, 50) and the computation and storage means (60, 70, 80) into a single apparatus for control, storage and computation, such apparatus being possibly a computer running software and controlling the device functionalities.

In another implementation of the device, illustrated in FIG. 2, the object or body (30) is maintained in a fixed position and a 3D camera is rotating around the subject by means of a rotating frame (21) carrying the 3D camera body (10) instead of having the subject (30) rotating in front of a fixed 3D camera. More precisely, in FIG. 2:

a rotating frame (21), rotating around the subject (30) and carrying a 3D camera (10),

a control mean controls the rotation (41) of the rotating frame (21).

The other elements of the device are mostly unchanged. The device of FIG. 2 can include the same implementation variations as the implementation variations proposed for the device of FIG. 1, that it, that the control mean triggering picture taking (50) by the 3D camera (10) and the control mean of the rotating frame (41) can be linked to their respective system via a cable or any type of electromagnetic wave or be synchronized by using a clock, and these two control means (50) and (41) can also be merged in a single control mean (41-50). Further, there is an advantage for the control mean of the rotation (41) to suspend the rotation of the rotating frame (21) during picture taking, in order to reduce motion blur.

In another possible implementation, not represented in a figure, the device can include robotic means enabling orienting or moving the 3D camera (10) over time. It can be for example a system to move up and down and/or orient the 3D camera (10) in order to collect 360° complete loops of the subject at different height positions and combining these loops at different height positions in order to reconstruct in 3D a comprehensive surface of a subject, which is particularly useful when the subject is elongated vertically, such as, for example, a standing person.

In another possible implementation of the device, also not represented in a figure, the device can comprise more than one passive stereovision 3D camera. One particularly useful variant would be to position these different 3D cameras vertically, such that, when the turn table or the rotating frame is performing a complete 360° loop, it is possible to simultaneously acquire 360° loops of the subject at different heights and to stitch all corresponding 3D surfaces into a single 3D surface and associated texture image. Once again, such implementation is specifically useful in the case of a vertically elongated subject, such as a standing person.

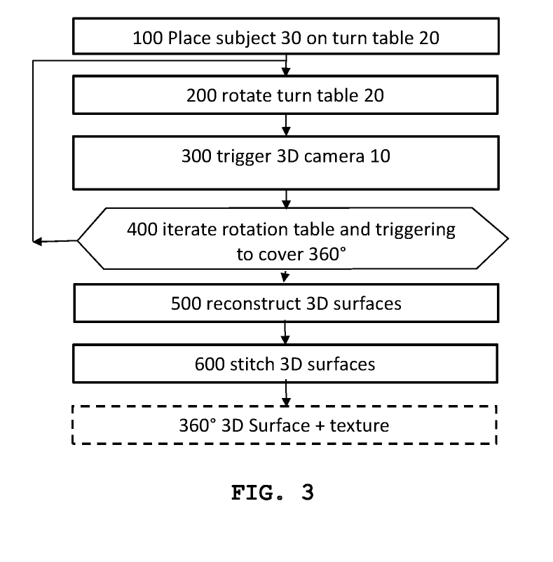

FIG. 3 is presenting a method according to the present invention and using a turn table to perform a 360° loop of the subject and including the steps of:

(100) positioning a subject (30) in the center of a turn table (20), such that the subject (30) is within the field of view of a fixed passive stereovision 3D camera (10),

(200) rotating the turn table (20) such that a given viewing angle between the subject (30) and the 3D camera (10) is achieved,

(300) triggering picture taking by the 3D camera (10) and store the corresponding stereo pair corresponding to this viewing direction in a storage mean (70),

(400) iterating between rotating (200) the turn table (20) and triggering (300) the 3D camera (10) in order to perform a complete 360° loop of the subject.

(500) reconstructing the 3D surfaces and associated texture images associated to each of the stereo pair corresponding to the different viewing angles,

(600) stitching all 3D surfaces and associated texture images into a single 3D surface and associated texture image to represent a 360° loop of the subject (30).

In a possible implementation of the method, the steps of reconstructing a 3D surface and associated texture image (500) within the iterations (400) is performed just after the step of stereo pair picture taking (300); the advantage being that the method is performed faster as the 3D surface reconstructions can be performed in parallel with picture taking.

In the same way, a possible improvement of the method can be to perform the step of 3D surface stitching (600) as and when each individual 3D surface corresponding to each of the stereo pairs is reconstructed.

In the same way as the proposed device, there is an advantage to use several 3D cameras instead of a single one and/or to progressively move vertically the 3D camera in order to perform several 360° loops around the subject at different height, which is particularly useful if the subject is vertically elongated, as it is the case of a standing person.

In another method according to the present invention, the 3D camera (10) is rotating around the subject (30) by using a rotating frame (21) carrying the 3D camera (10) instead of having a fixed 3D camera (10) and a subject (30) placed on a turn table (20) and rotating in front of the 3D camera (10).

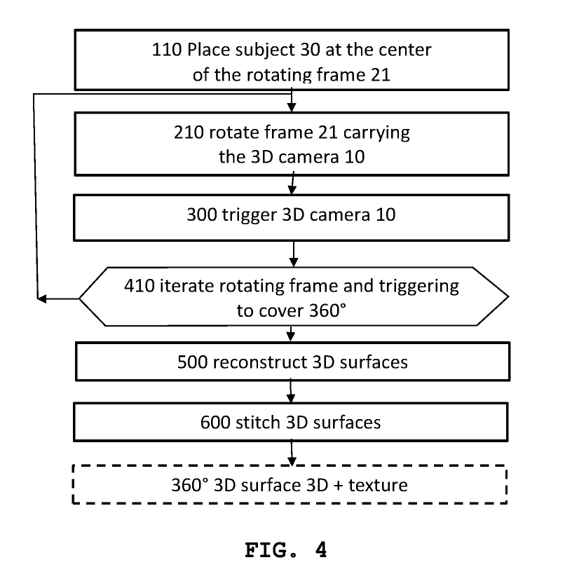

FIG. 4 is presenting such implementation of the method, making use of a rotating frame (21). In the method of FIG. 4, the differences with the implementation of FIG. 3 are that it starts to place (110) the subject (30) at the center of rotation of the rotating frame (21) carrying the passive vision 3D camera (10). It is followed by the step (210) of positioning the rotating frame (21) such as to achieve a pre-defined viewing angle between the 3D camera (10) and the subject (30). This process is then iterating (410) by alternatively taking picture (300) and rotating (210) the rotating frame (21) in order to achieve all the viewing angles necessary to cover a 360° loop around the subject (30). The other steps of the method are mostly unchanged when compared with the method of FIG. 3, and the implementation variations such as using several 3D cameras and/or moving vertically a 3D camera (10) in order to acquire several 360° loop at different heights apply, as well as the implementation variations in which the steps of 3D reconstruction (500) and stitching of the surfaces (600) are performed in parallel.

The presented device and method are useful to generate a 3D surface and associated texture image corresponding to a 360° loop of a subject, which can be an object or a body. Thanks to passive stereovision, the geometry of the surface is very accurate and the texture image is high resolution. It is useful to use the device and/or method for plastic surgery, in order to reconstruct in 3D complete 360° loops of people to measure their dimensions, to follow-up the evolution of these dimensions and shapes over time and/or to simulating surgical or aesthetic operations, in particular relative to body re-shaping and fat removal procedures of people.

What is claimed is:

1. A device to achieve 3D reconstruction of a surface of a 360° loop of an object or a body (30), comprising:
at least one passive stereovision camera 3D equipped with a double optics (10), and
a turn table (10) which is carrying the object or body to be imaged (30) or, alternatively, a rotating frame (21) carrying the at least one 3D camera (10) and rotating around the object or body to be imaged (30), configured such that the object or body (30) is within the field of view of the at least one 3D camera (10), and
a control mean (40) that manage the rotation of the turn table (20) or, respectively, a control mean (41) that manage the rotation of the rotating frame (41), and
a control mean (50) for remote triggering of the at least one 3D camera (10) and for acquiring stereo pairs of images according to viewing angles covering a 360° loop around the object or body (30), and
computation means (60) for the 3D reconstruction of 3D surfaces from the acquired stereo pairs of images, and
computation means (80) for the stitching in 3D of the acquired 3D surfaces into a comprehensive 3D representation of a complete 360° loop of the surface of the imaged object or body (30).

2. The device of claim 1, wherein the computation means (80) used for stitching are comprising running a matching algorithm to match the reconstructed 3D surfaces in order to stitch these surfaces together once matched.

3. The device of claim 1, wherein the computation means (80) used for stitching is comprising a looping algorithm which is adjusting the relative position of the successive reconstructed 3D surfaces in order to spread evenly the matching differences between the matched successive reconstructed 3D surfaces.

4. The device of claim 1, comprising a turn table (20) such that the object or body (30) is placed at the center of the turn table (20) and within the field of view of the at least one 3D camera (10), and a control mean (40) to manage the rotation of the turn table (20).

5. The device of claim 1, comprising a rotating frame (21) carrying at least one passive vision 3D camera (10) such that an object or body (30) placed at the center of rotation of the rotating frame (21) is within the field of view of the at least one 3D camera (10), and a control mean (41) managing the rotation of the rotating frame (21).

6. The device according to claim 1, comprising several passive vision 3D cameras, each equipped with a double optics.

7. The device according to claim 1, comprising robotic means to orient and/or move the at least one passive stereovision 3D camera (10).

8. The device according to claim 1, wherein the control mean (40) of the turn table (20) or, respectively, the control mean (41) of the rotating frame (21) are synchronized and/or merged with the control mean managing the triggering of picture taking into a single control mean (40-50) or (41-50) managing the acquisition of the stereo pairs corresponding to a set of viewing angles covering a complete 360° loop of the object or body (30).

9. The device according to claim 8, wherein the control mean managing the rotation and the triggering of picture taking (40-50) or (41-50) is including pre-defining a given number of relative viewing angles between the at least one 3D camera (10) and the object or body (30), and is managing the rotation of the turn table (20) or, respectively, of the rotating frame (21) in order that, for each pre-defined viewing angle, the control mean is:
placing the object or body (30) relative to the at least one passive stereovision 3D camera according to one of the predefined viewing angle, and
acquiring at least one stereo pair of images according to this relative viewing angle, and
moving the object or body (30) relative to the at least one 3D passive stereovision 3D camera (10) and iterating to achieve the predefined viewing angles in order to acquire the set of stereo pairs for the pre-defined viewing angles covering the 360° loop, and
reconstructing (60) and stitching (80) in 3D a comprehensive 3D reconstruction of the surface and associated texture image of the imaged object or body (30).

10. The device of claim 1, wherein the control mean for the rotation (40) of the turn table (20) or, respectively, for the rotation (41) of the rotating frame (21), is suspending the rotation during each picture taking.

11. A method comprising using the device according to claim 1 with the steps of:
(100-110) positioning (100) the object or body (30) on the turn table (20) or, respectively, positioning (110) the object or body (30) at the center of rotation of the rotating frame (21) carrying at least one passive stereovision 3D camera, such that the object or body (30) is within the field of view of the at least one passive stereovision 3D camera (10), and
(200-210) rotating (200) the turn table (20) or, respectively, rotating the rotating frame (21) carrying the at least one passive stereovision 3D camera (10) in order to position the at least one passive stereovision 3D camera (10) relative to the imaged object or body (30) according to a pre-defined viewing angle, and
(300) triggering the at least one passive vision 3D camera (10), and
(400-410) iterating (400) between rotating (200) the turn table (20) and triggering picture taking (300) or, respectively, iterating (410) between rotating (210) the rotating frame (21) carrying the at least one passive stereovision 3D camera (10) and triggering picture taking (300), in order to collect a set of stereo pairs of images taken according to viewpoints covering a complete 360° loop of the object or the body (30), and
(500) reconstructing in 3D the individual 3D surfaces and associated texture images of the object or body (30) from the stereo pairs acquired for each and all viewpoints, and
(600) stitching the set of individual 3D surfaces and associated texture images in a comprehensive 3D surface and associated texture image representing a complete 360° tour of the imaged object or body (30).

12. The method according to claim 11, wherein the step of stitching (600) is further comprising the sub-step of matching successive reconstructed 3D surfaces in order to stitch all these surfaces together once matched.

13. The method according to claim 11, wherein the step of stitching (600) is further comprising the sub-step of applying a looping algorithm to adjust the relative positions of the successive reconstructed 3D surfaces in order to spread evenly the matching differences between matched successive reconstructed 3D surfaces.

14. The method according to claim 11, comprising using a turn table (20) such that the object or body (30) is placed (100) on this turn table (20) and within the field of view of the at least one passive stereovision 3D camera, and wherein the relative placements between the object or body (30) and the at least one passive stereovision 3D camera are achieved by alternatively (400) rotating (200) the turn table (20) and triggering (300) the 3D camera (10) for all pre-defined viewing directions covering a complete 360° loop of the imaged object or body (30).

15. The method according to claim 11, comprising using a rotating frame (21) carrying the at least one passive stereovision 3D camera (10), and where the object or body (30) is placed (110) at the center of rotation of the rotating frame (21) and within the field of view of the at least one passive stereovision 3D camera (10), and wherein the relative placements between the object or body (30) and the at least one passive stereovision 3D camera (10) are performed by alternatively (410) rotating (210) the rotating frame (21) and triggering (300) the 3D camera (10) for all pre-defined viewing directions covering a complete 360° loop of the imaged object or body (30).

16. The method according to claim 11, wherein the rotation of the turn table (20) or, respectively, the rotation of the rotating frame (21), is stopped during each picture taking (300).

17. The method according to claim 11, wherein the step of 3D surface reconstruction (500) is performed within the iteration (400-410) each time the 3D camera (10) is triggered (300).

18. The method according to claim 11, wherein the step of stitching of the 3D surfaces (600) is performed in parallel with 3D surfaces reconstruction (500), within the iterative loop (400-410).
